(19) United States
(12) Patent Application Publication
(10) Pub. No.: US 2013/0312943 A1
(43) Pub. Date: Nov. 28, 2013

(54) PROCESS FOR PRODUCING AN INTEGRAL BOND

(71) Applicant: Behr GmbH & Co. KG, Stuttgart (DE)

(72) Inventors: Michael WERZ, Eningen (DE); Spasoje IGNJATOVIC, Illingen (DE); Rüdiger KÖLBLIN, Esslingen (DE); Klaus BONNERT, Köngen (DE); Stefan FELBER, Schwieberdingen (DE)

(73) Assignee: Behr GmbH & Co. KG, Stuttgart (DE)

(21) Appl. No.: 13/898,755

(22) Filed: May 21, 2013

(30) Foreign Application Priority Data
May 22, 2012 (DE) 10 2012 208 558.0

(51) Int. Cl. B23K 31/02; F28F 21/08

(52) U.S. Cl. CPC B23K 31/02; F28F 21/084
USPC 165/172; 228/208; 219/137 R

(57) ABSTRACT

This application provides, inter alia, processes for producing an integral bond between a high-grade steel component and an aluminum or aluminum alloy component. In an exemplary embodiment, the process comprises coating the high-grade steel first with a nickel layer and second an aluminum layer, arranging the coated high-grade steel and the aluminum or aluminum alloy components in relation to one another in such a manner that partial regions of the first and of the second component are arranged parallel to one another and either bear areally against one another or are arranged with a gap of 0 mm to 5 mm in relation to one another, and integrally bonding the coated high-grade steel component to the aluminum or aluminum alloy component by using a cold metal transfer process.

### TECHNICAL FIELD

The invention relates to a process for producing an integral bond between a first component made of high-grade steel and a second component made of aluminum or an aluminum alloy.

Furthermore, the invention relates to a heat exchanger with an integral bond between a housing and at least one tube plate, in particular a tube-bundle heat exchanger for cooling exhaust gases from an internal combustion engine, having a multiplicity of tubes which conduct a first fluid and are accommodated in their end regions in the tube plate, and having a housing which surrounds the tubes, wherein a second fluid can flow through the housing and the second fluid can flow around the tubes, wherein the tube plate is inserted in the housing in such a way that a first duct conducting the first fluid is sealed off from a second duct conducting the second fluid.

### PRIOR ART

In present-day prior art, exhaust-gas heat exchangers are often produced completely from high-grade steel. This is due to the high demands in terms of the exhaust-gas temperatures and the corrosive properties of the exhaust gases. At present, high-grade steel heat exchangers of this type are joined by welding processes, for instance laser or MAG welding.

Alternatively, according to the prior art, heat exchangers made from combinations of high-grade steel and aluminum are produced by way of screwed flange connections, i.e. by way of form-fitting connections, since to date it has not been possible to integrally bond aluminum to high-grade steel by using the known thermal joining processes, for instance MIG/MAG welding or the cold metal transfer process.

This necessitates inter alia additional components, for instance seals, and in addition this makes the demands in terms of the tolerance positions of the components particularly high for ensuring a fluidtight connection between the components.

For technical reasons, it is increasingly necessary to integrally bond aluminum and high-grade steel for use in heat exchangers, and therefore it is necessary to provide a process for integrally joining aluminum and high-grade steel components.

In this respect, it is disadvantageous in the prior art in particular that to date no suitable process has been available for integrally bonding aluminum and high-grade steel components.

### SUMMARY OF THE INVENTION, OBJECT, SOLUTION, ADVANTAGES

Therefore, it is an object of the present invention to provide a process which makes it possible to produce integral bonds between high-grade steel and aluminum or aluminum alloys.

The object of the present invention is achieved by a process having the features of Claim 1. Advantageous developments of the present invention are described in the dependent claims.

It is advantageous if the following steps are carried out for producing an integral bond between a first component made of high-grade steel and a second component made of aluminum or an aluminum alloy:
coating of the high-grade steel component with a nickel layer,
coating of the high-grade steel component coated with the nickel layer with an aluminum layer,
arranging the high-grade steel component coated with the nickel layer and the aluminum layer and the aluminum component or the aluminum alloy component in relation to one another in such a manner that partial regions of the first and of the second component are arranged parallel to one another and either bear areally against one another or are arranged with a gap of 0 mm to 5 mm in relation to one another,
integral bonding of the coated high-grade steel component to the component made of aluminum or of an aluminum alloy by using the cold metal transfer process.

The use of the cold metal transfer process makes it possible to join the two materials to one another in a very precise manner. Here, only a very small introduction of heat occurs at the components involved, which is advantageous in terms of further processing. In addition, the high possible process speed provides for good applicability for large-scale production. The ability to bridge large gaps makes it possible to join components with relatively large tolerances using the process.

It is also advantageous if the aluminum layer is applied directly to the nickel layer. This forms a two-layered coating on the high-grade steel surface, which is advantageous for carrying out the cold metal transfer process and promotes the production of a permanent integral bond.

Furthermore, it is advantageous if the nickel coating and/or the aluminum coating of the high-grade steel component is produced by galvanization. The galvanization makes it possible to produce different layer thicknesses, which have a good bond to the carrier surfaces. The layers can thereby be adapted effectively to the planned use.

In an alternative embodiment, it is advantageous if an MIG welding process is used instead of the cold metal transfer process.

It is also advantageous if the components are the housing and a tube plate of a heat exchanger. By virtue of the integral bond which is produced between the tube plate and the housing, the housing is sealed off to the outside, as a result of which a second flow duct is formed within the housing.

Preference is also to be given to a heat exchanger with an integral bond between a housing and at least one tube plate, in particular a tube-bundle heat exchanger for cooling exhaust gases from an internal combustion engine, having a multiplicity of tubes which conduct a first fluid and are accommodated in their end regions each in a tube plate, and having a housing which surrounds the tubes, wherein a second fluid can flow through the housing and the second fluid can flow around the tubes, wherein the tube plates are inserted in the housing in such a way that a first duct conducting the first fluid is sealed off from a second duct conducting the second fluid, wherein the housing consists essentially of high-grade steel, and the tube plates and the multiplicity of tubes conducting the first fluid consist essentially of aluminum or an aluminum alloy.

It is advantageous if the bond between the housing and the tube plates is produced in an integral manner by a thermal joining process. This ensures that the bond has a sufficiently large sealing action, such that additional sealing measures can be dispensed with.

According to an alternative embodiment, it is preferable if the housing is coated with a nickel layer and an aluminum layer at the joints with the tube plate which are arranged at the end regions of the housing. The coating of the housing made of high-grade steel supports the bond to the aluminum material and thus helps to obtain a better bond result.

In addition, it is advantageous if the housing and the tube plate are integrally bonded to one another in the interior of the housing. Owing to the integral bond between the tube plate and the housing in the interior of the housing, it is easier to produce the bond per se, since the shape of the tube plates is based on the inner contour of the housing.

### BRIEF DESCRIPTION OF THE DRAWINGS

Hereinbelow, the invention will be explained in detail on the basis of an exemplary embodiment with reference to the drawing. In the drawing:

FIG. 1 shows a perspective view of a heat exchanger, in particular of a tube-bundle heat exchanger,

FIG. 2 shows a section of a detail of the joint between the housing and the tube plate, and

FIG. 3 shows a flow chart illustrating the individual process steps.

### PREFERRED EMBODIMENT OF THE INVENTION

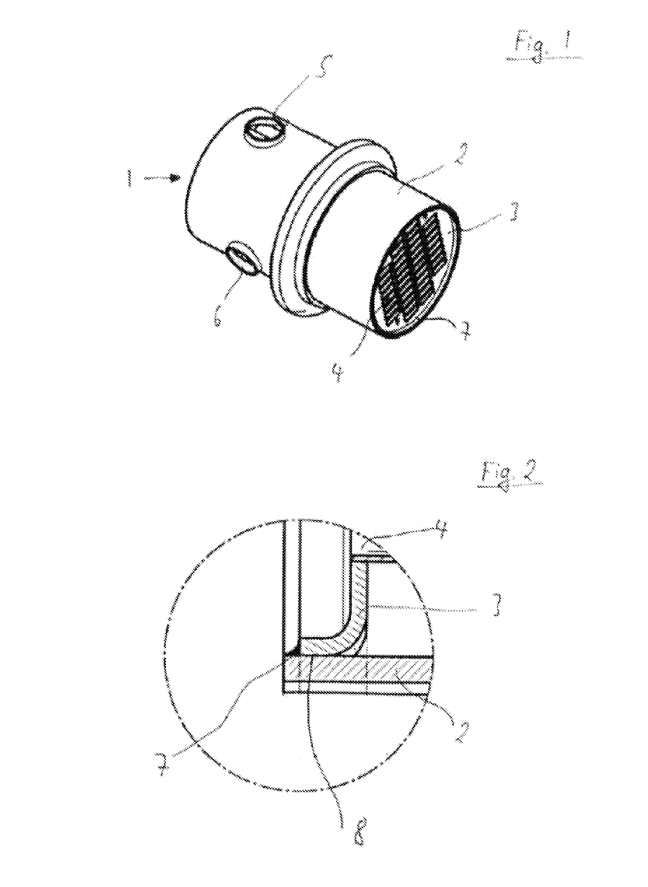

FIG. 1 shows a perspective view of a heat exchanger 1. The heat exchanger 1 shown is in particular a tube-bundle heat exchanger consisting essentially of the housing 2. A plurality of tubes 4, through which a first fluid can flow to the heat exchanger 1, are arranged in the interior of the housing 2. These tubes 4 are accommodated at their two end regions in tube plates 3.

At both ends of the heat exchanger 1, the tube plates 3 are joined to the housing 2. In the example shown here, the tube plates 3 are welded to the inner surface of the housing 2. The weld seam 7 runs circumferentially along the tube plate 3 on the inner surface of the housing 2.

The housing 2 of the heat exchanger 1 furthermore has a coolant inlet opening 6 and also a coolant outlet opening 5. A further, second fluid can flow through the housing 2 through these two openings, the fluid flowing around the tubes 4 located in the interior of the housing 2.

FIG. 1 does not show further connection elements, which can be fitted to the side of the housing 2 of the heat exchanger 1 in order to feed the first fluid, flowing through the tubes 4 in the interior of the housing 2, to the housing 2 or carry it away from the housing 2.

The heat exchanger 1 shown in FIG. 1 consists essentially of two materials. The housing 2 of the heat exchanger 1 consists essentially of a high-grade steel. The tube plates 3 and the tubes 4 accommodated in the tube plates consist of aluminum or an aluminum alloy. Forming the tube plates 3 and the tubes 4 from aluminum or an aluminum alloy serves to reduce the weight of the overall system of the heat exchanger 1.

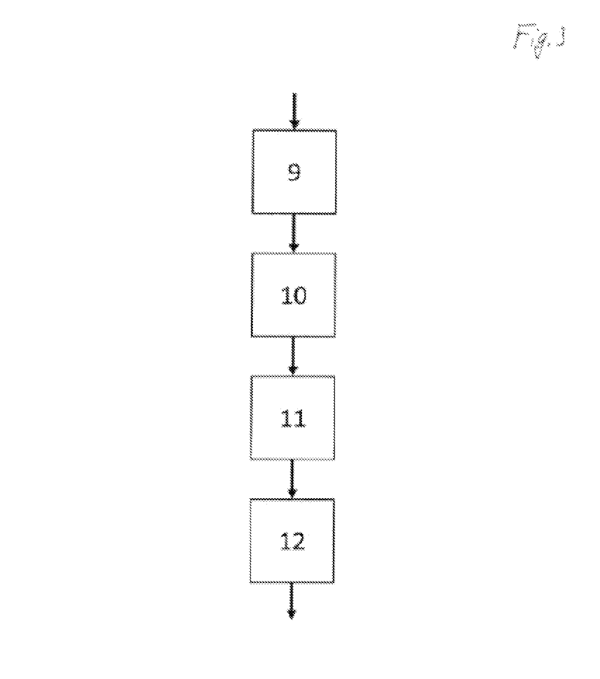

FIG. 2 shows a detailed view of the joint 8 which is formed between the tube plates 3 and the housing 2. It can be seen that the tube plate 3 is arranged in particular in one of the end regions of the housing 2. As already mentioned for FIG. 1, the tube plate 3 is welded to the housing 2 circumferentially on the inner surface of the housing 2. In the section shown in FIG. 2, the weld seam 7 can clearly be seen.

In the example shown here, the tube plate 3 is positioned close to the end region of the housing 2 in areal contact. In alternative embodiments, however, it is conceivable to position the tube plate 3 more to the center of the heat exchanger 1 or of the housing 2, in particular for an adequate edge offset which forms the space for the weld seam 7 and/or minimizes the introduction of heat.

Similarly, in the illustration shown here, the tube plate 3 is positioned freely in the interior of the housing 2. In other embodiments, it is similarly conceivable for the inner side of the housing 2 to be provided with a circumferential edge or a shoulder, on which the tube plate 3 is arranged.

The cold metal transfer process and also the MIG welding process can also bridge a certain gap between the two components to be bonded to one another. In alternative embodiments, it is therefore likewise conceivable that the tube plate and the housing are not arranged in areal contact with one another before the tube plate is bonded to the housing, but rather there is a gap of approximately 0 mm up to approximately 3 mm therebetween.

FIG. 3 shows a flow chart with four process steps 9, 10, 11, 12 for illustrating the process for bonding high-grade steel and aluminum or aluminum alloys. In the exemplary embodiment according to the invention, the cold metal transfer process is provided for bonding the tube plate 3 to the housing 2. In order to make it possible to bond aluminum materials or aluminum alloys to high-grade steel by means of the cold metal transfer process, the high-grade steel component has to be pretreated.

For this reason, the housing 2 has a coating in the inner region of the joint 8 and particularly in the region of the weld seam 7.

For this purpose, in a first process step 9, a nickel layer is applied to the high-grade steel component. This preferably takes place in the region in which the bond is also to be formed later. An extent of the coated surface beyond this is also conceivable, however.

In a second process step 10, an aluminum layer is applied to the high-grade steel component to which a nickel layer has already been applied in the first process step 9. This, too, is preferably restricted to the region in which the bond between the high-grade steel and the aluminum part is formed, and here the aluminum layer is applied directly to the nickel layer applied in the first process step 9. After the first and second process steps 9, 10, the housing 2 then has two layers lying one above another.

The two layers just described can expediently be applied to the inner surface of the housing 2 by galvanic treatment, for example.

In a third process step 11, after the inner surface of the housing 2 has been coated, the high-grade steel component coated with nickel and aluminum is then positioned in relation to the aluminum or aluminum alloy component. The high-grade steel component coated with the nickel layer and the aluminum layer and the aluminum component or the aluminum alloy component are arranged in relation to one another in such a manner that they have an edge offset at the end face. The edge offset forms the space for the weld seam 7 and minimizes the introduction of heat.

In the case of the exemplary embodiment shown, the tube plates 3 together with the received tubes 4 are therefore positioned in the interior of the housing.

In a fourth process step 12, the high-grade steel component is then integrally bonded to the aluminum or aluminum alloy component by means of the cold metal transfer process.

As an alternative to the use of the cold metal transfer process, it is conceivable to use an MIG welding process. For this purpose, the inner surface of the housing 2 is pretreated in a similar manner as for the use of the cold metal transfer process.

1. A process for producing an integral bond between a first component made of high-grade steel and a second component made of aluminum or an aluminum alloy, wherein the following steps are carried out:
coating of the high-grade steel component with a nickel layer,
coating of the high-grade steel component coated with the nickel layer with an aluminum layer,
arranging the high-grade steel component coated with the nickel layer and the aluminum layer and the aluminum component or the aluminum alloy component in relation to one another in such a manner that partial regions of the first and of the second component are arranged parallel to one another and either bear areally against one another or are arranged with a gap of 0 mm to 3 mm in relation to one another,
integral bonding of the coated high-grade steel component to the component made of aluminum or of an aluminum alloy by using the cold metal transfer process.

2. The process according to claim 1, wherein the aluminum layer is applied directly to the nickel layer.

3. The process according to claim 1, wherein the nickel coating and/or the aluminum coating of the high-grade steel component is produced by galvanization.

4. The process according to claim 1, wherein an MIG welding process is used instead of the cold metal transfer process.

5. The process according to claim 1, wherein the components are the housing and a tube plate of a heat exchanger.

6. A heat exchanger with an integral bond between a housing and at least one tube plate, in particular produced by a process according to claim 1, in particular a tube-bundle heat exchanger for cooling exhaust gases from an internal combustion engine, having a multiplicity of tubes which conduct a first fluid and are accommodated in their end regions each in a tube plate, and having a housing which surrounds the tubes, wherein a second fluid can flow through the housing and the second fluid can flow around the tubes, wherein the tube plates are inserted in the housing in such a way that a first duct conducting the first fluid is sealed off from a second duct conducting the second fluid, wherein the housing consists essentially of high-grade steel, and the tube plates and the multiplicity of tubes conducting the first fluid consist essentially of aluminum or an aluminum alloy.

7. The heat exchanger according to claim 6, wherein the bond between the housing and the tube plate can be produced in an integral manner by a process for producing an integral bond between a first component made of high-grade steel and a second component made of aluminum or an aluminum alloy, wherein the following steps are carried out:
coating of the high-grade steel component with a nickel layer,
coating of the high-grade steel component coated with the nickel layer with an aluminum layer,
arranging the high-grade steel component coated with the nickel layer and the aluminum layer and the aluminum component or the aluminum alloy component in relation to one another in such a manner that partial regions of the first and of the second component are arranged parallel to one another and either bear areally against one another or are arranged with a gap of 0 mm to 3 mm in relation to one another,
integral bonding of the coated high-grade steel component to the component made of aluminum or of an aluminum alloy by using the cold metal transfer process.

8. The heat exchanger according to claim 6, wherein the housing is coated with a nickel layer and an aluminum layer at the joints with the tube plate which are arranged at the end regions of the housing.

9. The heat exchanger according to claim 6, wherein the housing and the tube plate are integrally bonded to one another in the interior of the housing.
